(19) United States
(12) Patent Application Publication
(10) Pub. No.: US 2005/0194406 A1
(43) Pub. Date: Sep. 8, 2005

(54) Apparatus for the discharge of bulk bags

(76) Inventor: Mark Michael Kosich, Bailey, NC (US)

Correspondence Address: MARK KOSICH, PO BOX 3171, WILSON, NC, 27895, US

(21) Appl. No.: 10/937,865

(22) Filed: Sep. 9, 2004

Related U.S. Application Data
(63) Continuation-in-part of application No. 10/791,520, filed on Mar. 2, 2004.

(51) Int. Cl. B65D 30/08; B67D 5/06

(52) U.S. Cl. 222/181.1

(57) ABSTRACT

An apparatus that allows for handling a bulk bag as an invertible container similar to a drum. An adapter assembly is fitted to the bag spout. Perimeter retainer components mount onto a machine designed for inverting a container. The perimeter retainer components secure the perimeter of a bulk bag when it is inverted so that product discharges through an inlet/outlet spout prepared with an adapter assembly. A preferred method involves pre-staging an adapter assembly to a bulk bag disposed in an upright position within a machine designed to invert a container, engaging the bulk bag spout with the adapter assembly, inverting the bulk bag so that bag attachment adapters engage the perimeter retainers and using the adapter assembly with a flow control valve to control the flow of product from the bulk bag.

### CROSS REFERENCE TO RELATED APPLICATIONS

This is a continuation in part of Ser. No. 10/791,520, filed on Mar. 2, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of the discharge of product from bulk bags and more specifically to an apparatus for the discharge of bulk bags in a manner similar to that of inverting and discharging a drum or other rigid type container. The spout of a bulk bag is prepared with an adapter assembly that can be fitted with a valve or flow control device while the perimeter of the bulk bag is retained by components that can be mounted upon a machine designed to invert a container and bag attachment means provided on the bulk bag. A method for handling a bulk bag in a manner similar to a drum or other rigid container comprises the steps of disposing the bulk bag upward within a machine designed to invert a container; attaching the adapter assembly to the bulk bag spout; engaging the bulk bag attachment means with the perimeter retainer means; contracting a stabilizer arm; inverting the bulk bag; extending the stabilizer arm; and opening the valve or flow control device

Bulk bags are inexpensive intermediate containers constructed of woven polypropylene or polyester fabric. Used for shipping products of many kinds, this discussion relates primarily to bulk bags containing products classified as bulk solids. Bulk bags are used in many industries to transport and store chemicals, plastic resins, food ingredients, pharmaceutical intermediates and various powder and granular products along with many other variations of products with different particle type and size. Bulk bags are typically constructed in a cube shape and sometimes in a cylindrical shape.

Typical bulk bag sizes can range from 35 to 48 inches square while height can range from 30 inches to 72 inches. Bags are usually filled through a top spout 14 to 18 inches in diameter that is tied off and they are discharged from a bottom spout about 12 to 20 inches in diameter that also has a tie string. Spout length can vary but is typically between 10 and 24 inches long.

Bulk bags are shipped with the with the outlet on the bottom then lifted onto a framework to support the bulk bag. Usually it is suspended by four loops located around the top corners of the bulk bag. An operator reaches underneath the bulk bag, then connects the outlet spout to a chute that is connected to a process inlet, metering device or conveying device. The operator then unties the outlet spout.

Numerous optional items have evolved for dealing with spout closure for re-tying the outlet spout, compensating for bag drooping as product empties, dust control and coaxing hardened product to flow. These optional items are mounted on the bulk bag discharger framework located over the process inlet or conveyor inlet.

Present method dischargers, usually standing 12 to 15 feet tall, occupy a large volume of space and deliver the product to floor level. To bring the product up to a height where it can be delivered to a process inlet requires either a very high ceiling or the use of conveyors which consume a significant amount of horizontal space. Hanging a bulk bag by loops located on the top corners takes up excess vertical space. As product discharges from a bulk bag, the entire container will elongate, hence the bag must be drawn upward to alleviate folds in the bag fabric and prevent product from lodging in the folds.

Furthermore, conventional bulk bag discharging equipment does not allow for the same speed of changeover and ease of accurate metering as other types of containers. Since an operator must work from underneath the bulk bag to connect an outlet spout and initiate product flow, preparing a bulk bag for discharge is an uncomfortable, time consuming task. Disconnecting the outlet spout requires the operator to return underneath the bulk bag.

Because the product contained in the bulk bag rests just above the tie string, special enclosures and clamping devices are required to attach the outlet spout. Often, vacuum systems are employed help to minimize dust emission. Process area hygiene is a persistent problem with present method bulk bag discharging. is a persistent problem with present method bulk bag discharging.

### BRIEF SUMMARY OF THE INVENTION

It is an object of the invention to pre-stage a bulk bag for discharge in an upright position.

It is another object of the invention to allow a bulk bag to be inverted for product discharge.

Another object of the invention is to handle a bulk bag as a drum or other rigid container.

It is another object of the invention to adapt a container inverter to handle bulk bags Another object of the invention is to retain the perimeter of a bulk bag while it is inverted during discharge

Another object of the invention is to support the body of a bulk bag upright while it is inverted for discharge

It is another object of the invention to completely empty the contents of a bulk bag

Another object of the invention is to provide rapid changeover of bulk bags at a process inlet.

Another object of the invention is to provide flow control from a bulk bag outlet.

Yet another object of the invention is to provide dust free handling.

A further object of the invention is to provide a bulk bag for discharge with a low ceiling height.

Still yet another object of the invention is to minimize bulk bag discharger equipment at the process area.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for the discharge of bulk bags comprising: an adapter section including an outwardly extending flange adapted for being engaged by a connecting means, an extension adapter section with matching outwardly extending flange adapted for being engaged by a connecting means, and a connecting means to secure said adapter section and said extension adapter section together

In accordance with another embodiment of the invention, there is disclosed an apparatus for the discharge of bulk bags comprising: a valve or flow control device adapted to be connected to said adapter extension section

In accordance with another embodiment of the invention, there is disclosed an apparatus for the discharge of bulk bags comprising: a stabilizer arm bracket mounted on a machine designed to invert a container, to stabilize a bulk bag while inverting and to extend the spout of a bulk bag

In accordance with a preferred embodiment of the invention, there is disclosed an apparatus for the discharge of bulk bags comprising: perimeter retainer means, to hold a bulk bag in position while inverted for discharging its contents

In accordance with a preferred embodiment of the invention, there is disclosed an apparatus for the discharge of bulk bags comprising: means to support a bulk bag body upright

In accordance with a preferred embodiment of the invention, there is disclosed an apparatus for the discharge of bulk bags comprising the step(s) of:
a) disposing said bulk bag with said spout facing upward within a machine for inverting a container,
b) connecting said bag attachment means to said perimeter retainer means as required,
c) connecting said means to support said bulk bag body upright (if supplied),
d) positioning said adapter assembly over said spout of said bulk bag either manually or by lowering said stabilizing member of said machine for inverting a container,
e) separating said adapter section and said extension adapter section,
f) pulling said bulk bag spout up and through adapter section orifice and folding said spout down over said flange of said adapter section,
g) placing said extension adapter section matching flange over said folded spout and over said adapter assembly flange,
h) engaging said extension section flange firmly over said adapter section flange utilizing said connection means,
i) raising (if supplied with a lift) and inverting said bulk bag,
j) positioning said bulk bag over desired apparatus,
k) lowering said stabilizing member of said machine for inverting a container, thereby lowering said adapter assembly and extending the belly of said bulk bag
l) activating said flow control device to controllably allow said material to flow, and
m) activating said flow control device to controllably stop said material flow

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view of an adapter assembly.

FIG. 2 is an exploded plan view of an adapter assembly.

FIG. 3 is an elevational view of an adapter assembly engaged with a bulk bag spout.

FIG. 4 is an elevational view of an adapter assembly with a V clamp.

FIG. 5 is an elevational view of an adapter assembly with a multi part clamp.

FIG. 6 is a perspective view of a framework surrounding the lower portion of an adapter assembly.

FIG. 7 is a perspective view of a framework surrounding the lower portion of an adapter assembly with channels.

FIG. 8 is a perspective view of an adapter assembly with a hinged connection between upper and lower components.

FIG. 9 is a plan view of an adapter assembly with a hinged connection between upper and lower components.

FIG. 10 is an elevational view of an exemplary bulk bag.

FIG. 11 is a plan view of an exemplary bulk bag.

FIG. 12 is a perspective view of a perimeter retainer used for a bulk bag with loops and means to support a bulk bag bag upright.

FIG. 13 is a perspective view of a bulk bag with loops secured to perimeter retainers mounted on a machine for inverting containers.

FIG. 14 is a perspective view a perimeter retainer used for a bulk bag with horizontal sleeves and means to support a bulk bag upright.

FIG. 15 is a perspective view of a bulk bag with horizontal sleeves secures to perimeter retainers mounted on a machine for inverting containers.

FIG. 16 is an exploded view of the invention.

FIG. 17 is a perspective view of the invention.

FIG. 18 is a plan view of the invention.

FIG. 19 is an elevational view of a machine for inverting containers.

FIG. 19A is a plan view of machine for inverting containers.

FIG. 20 is an elevational view of a machine for inverting containers.

FIG. 20A is a plan view of machine for inverting containers.

FIG. 21 is an elevational view of a machine for inverting containers.

FIG. 21A is a plan view of machine for inverting containers.

FIG. 22 is an elevational view of a machine for inverting containers.

FIG. 22A is a plan view of machine for inverting containers.

FIG. 23 is an elevational view of the invention.

FIG. 24 is an elevational view of the invention.

FIG. 25 is an elevational view of the invention.

FIG. 26 is an elevational view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

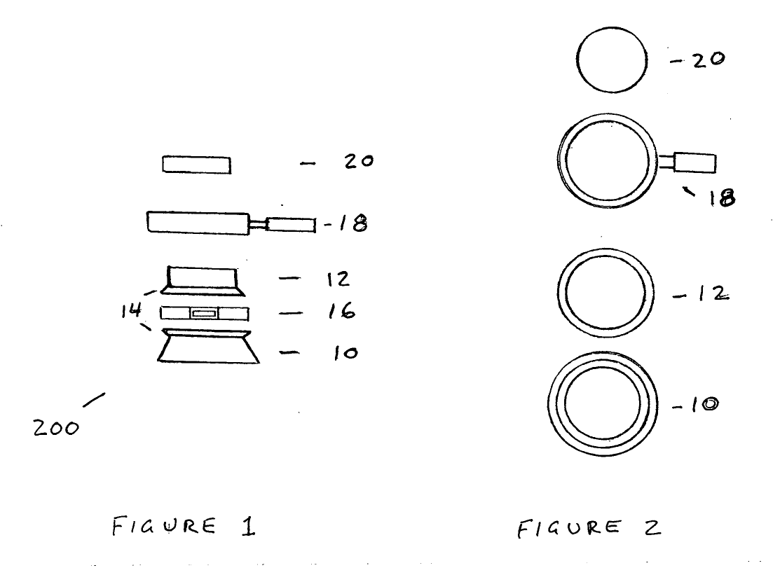

Turning first to FIG. 1, the components of an exemplary adapter assembly 200 with a flow control valve 18 are shown in an exploded view. Adapter section 10 rests over a spout 54 on a bulk bag 50 that is disposed with the spout 54 facing upwards. Extension adapter section 12 with flow control valve 18 and outlet spool piece 20 are lowered onto adapter section 10 and secured about outwardly extending flange 14 adapted for being engaged by a connecting means disposed on the upper peripheral edge of adapter section 10 and the lower peripheral edge of extension adapter 12 with a type of clamp, shown as a V clamp 16. The flange 14 may take a number of forms, but preferably it is a circular section bead machined for excellent surface contact with the bag spout 54 folded between adapter section 10 and extension section 12. Another form could be similar to that of the top ring of a conventional storage drum. It is to be noted that flow control valve 18 can be substituted with any of the family of valves or flow control devices including those presently available or of those that may become available in the future. Additionally, adapter assembly 200 can be comprised in a form that is cylindrical, conical, square or any desired geometric design so long as it provides a means for adapting bulk bag 50 spout 54 for control of product flow from bulk bag 50.

FIG. 2 provides a plan view of the components of FIG. 1, not including clamp 16.

The adapter assembly 200 may be constructed of any material which will support the expected weight of the head pressure of the product in the bulk bag 50. For example, the adapter assembly 200 may be fabricated from welded or spun steel, However, it is desirable to make the adapter assembly 200 as lightweight as possible. This allows the adapter assembly to be placed on to a bulk bag 50 manually or to be handled for cleaning without the need for lifting equipment. Accordingly, the adapter assembly 200, may be made from other materials such as aluminum, alloy, titanium, plastic or composite materials.

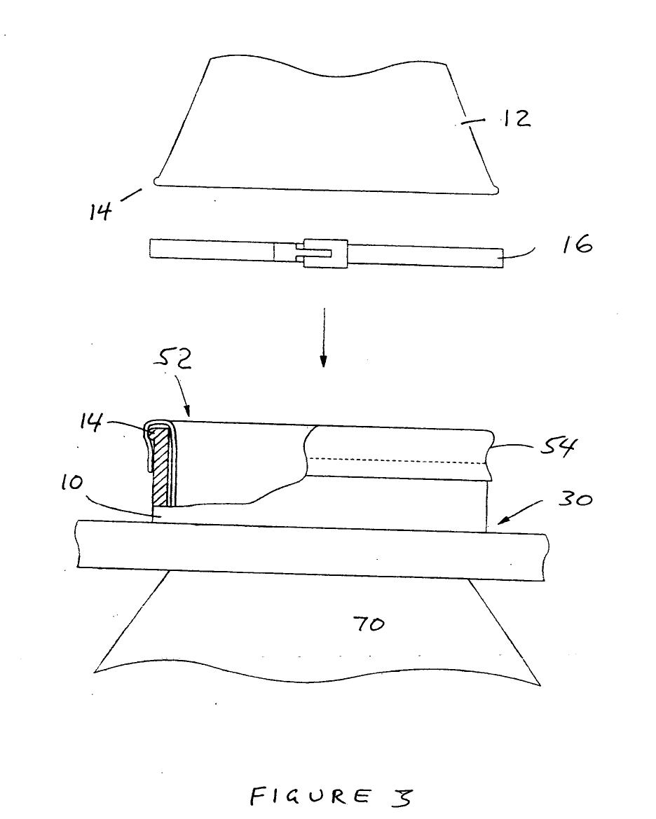

FIG. 3 shows how the adapter assembly 200 can be attached to a bulk bag 50. When the bulk bag 50 is in an upright position with the spout 54 facing up, adapter section 10 is placed on top of the bulk bag top section 70, over the spout 54. The spout 54 is pulled up through the center of adapter section 10. The spout 54 is folded outward and down over the flange 14 and against the side of adapter section 10. The spout 54 can be clamped against adapter section 10, for example using a drum ring clamp 16 of a known type. The clamp may also be used to attach extension adapter section 12. Once the bulk bag spout 54 is clamped in place the bulk bag spout 54 provides an annulus 52 through which product can discharge. A lid can also be attached to adapter section 10 in order to store the bulk bag before discharging it, or to close off a partially discharged bulk bag 50 with the adapter assembly still attached. The adapter assembly 200 may take a number of different forms, so long as it includes a means for supporting the spout 54 of the bulk bag 50 and for providing a connection to whatever flow control device 18 is being used.

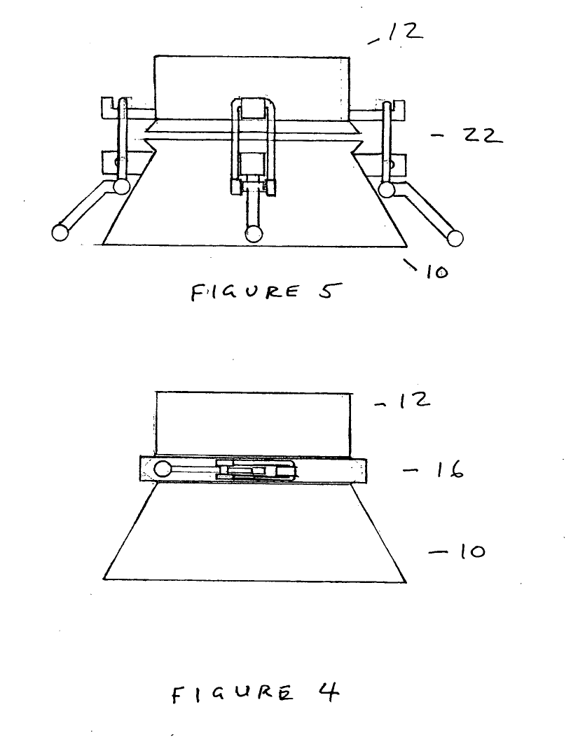

FIG. 4 shows adapter section 10 clamped to extension adapter section 12 using a surrounding type clamp that may be a V clamp 16, drum clamp 16 or other single or multi section clamp 16.

FIG. 5 shows several multi part clamps that engage adapter section 10 to extension adapter section 12. A multi part clamp 22 can be used for quick connect and disconnect while the parts remain attached to adapter assembly 200. One or more multi part clamps 22 can be used.

As shown in FIG. 6, a framework 30 can be adapted to either adapter section 10 or extension adapter 12. A preferred approach is shown in FIG. 6 with adapter assembly 10 surrounded by a framework 30.

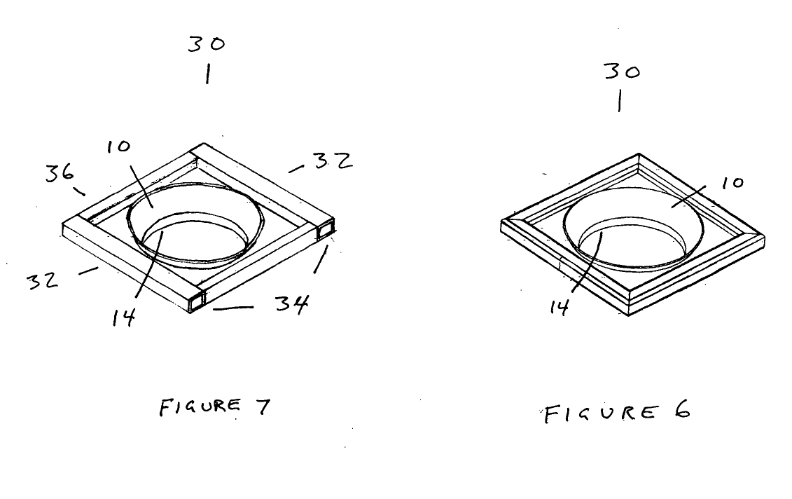

FIG. 7 shows framework 30 encompassing adapter assembly 200 with tube or channel material constructed with open ends 34 on members 32 to receive prong or tine like extensions from stabilizer 620. Opposite members 36 can be closed end and provide bracing for members 32. Stabilizer 620 inserts into the open ends 34 of framework 30 so that adapter assembly 200 can be mounted on stabilizer 620 and can be adjusted to center adapter assembly 200 over the center of bulk bag 50. Another alternative could be to have a custom shaped bracket similar to 520 with slots (not shown) so that the bracket 520 can be adjusted to locate properly onto adapter assembly 200 and its framework 30.

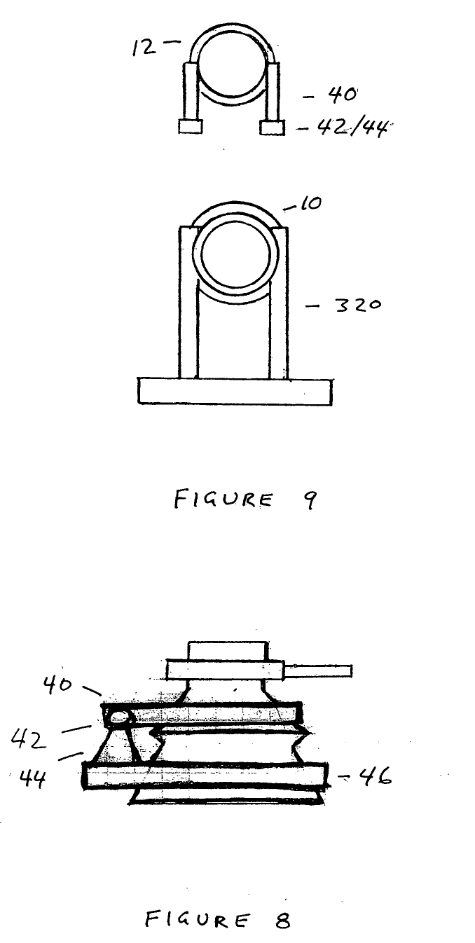

Turning to FIG. 8, at least one multi part clamp 22 can also be used in conjunction with a moveable means with support brackets moveably interconnecting the adapter assembly 200 sections allowing top portion extension adapter section 12, to be unclamped, opened, closed and clamped while remaining connected to the bottom portion, adapter section 10. An exemplary connection is shown with a base bracket 46 connected to adapter section 10 supporting a connecting member 44 to a hinge 42 that allows a top section bracket 40 connected to extension adapter section 12 to pivot up and down. Several alternatives can accomplish the same task of removing extension adapter section 12 from adapter section 10 while remaining connected. Pivoting components can alternatively be used to allow side to side swinging motion of extension adapter section 12 away from adapter section 10. Also, linear lifting components can allow extension adapter section 12 to lift vertically off of adapter section 10.

FIG. 9 illustrates an plan view of the upper and lower components showing base bracket 46 as a stabilizer arm 320 that extends from a machine for inverting a container, for example, 300 or 700. Adapter section 10 is mounted directly on stabilizer arm 320, while a connecting member 44 with hinge 42 supports extension adapter section 12.

Exemplary bulk bag 50 is illustrated in elevational view FIG. 10 and plan view FIG. 11. In the preferred construction, bulk bag 50 is constructed with a top section that will form an elongated cone 70 when inverted, however, it is not necessary to the proper function of retaining the bulk bag 50 perimeter and lowering the spout 54 with or without adapter assembly 200 attached. The cone shaped top 70 is to provide product flow characteristics similar to that of a steel or plastic portable bin with similar cone section. In the illustrated example, bag attachment means, shown as loops 56 are located at the top corners. Loops 56 can be stitched along cone section 70 to support inverted bulk bag 50 while filling loops 58 can be used during the filling of bulk bag 50 in an upright position.

Retaining the bulk bag perimeter when inverted may be done in various ways without departing from the present invention. Bag attachment means 56 to retain a bulk bag 50 when inverted may include but are not limited to: loops, pockets, sleeves, strings, tabs, tabs with eyelets, tabs with Velcro, straps, rings, rigid adaptations, hooks or clamps positioned preferably about the top perimeter of a pre-inverted bulk bag 50, hence, would be positioned about the bottom perimeter of a post-inverted bulk bag. It is also possible that any of the perimeter retainer means 56 mentioned above can be used to support the bulk bag 50 while filling. However, in plants where filling machines are already installed, standard filling loops 58 could prove to be helpful.

Bulk bag 50 is shipped and stored with outlet opening 52 in the up position while cone section 70 is folded flat upon bulk bag body 64. Means 90 to support bag sides 64 upright during product discharge can be inserted through side support means 60 shown as side sleeves with closed ends 62 on the bottom. Alternative side support means 60 adaptations illustrated as side sleeves 60 along bulk bag sides 64 can include but are not limited to: loops, pockets, sleeves, strings, tabs, tabs with eyelets, tabs with Velcro, straps, rings, rigid adaptations, hooks or clamps and can be designed to accept an inserting member 90 and can also be designed to attach to alternative means to support a bulk bag body upright 90 supplied with a connecting adaptation. Accordingly, means to support a bulk bag body upright can be of varying design to be adapted to such alternative bag adaptations without departing from the present invention.

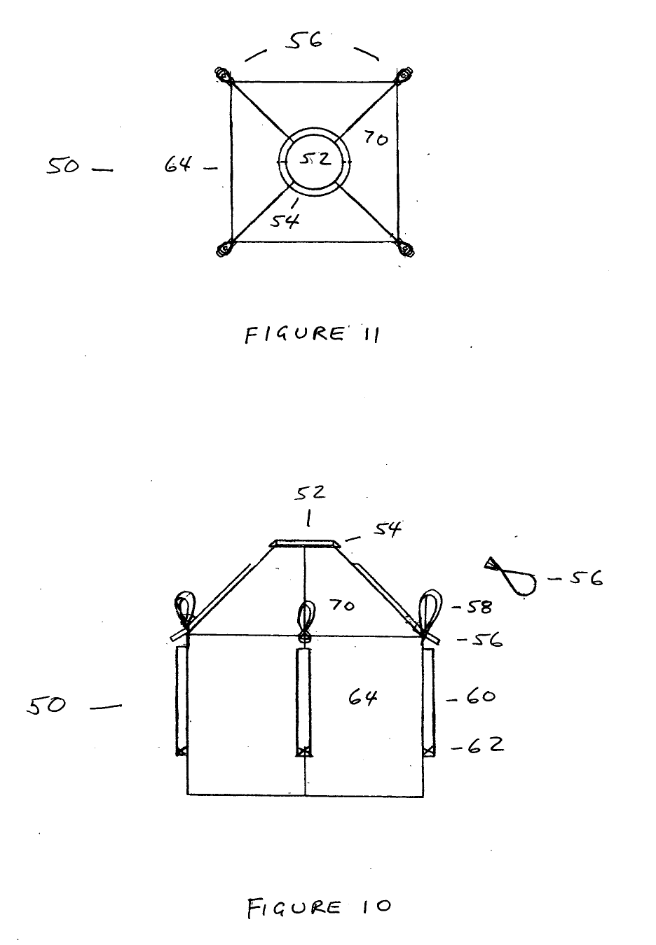

In accordance with an important feature of the present invention, there is shown in FIG. 12, perimeter retainer means 80. In a preferred embodiment, perimeter retainer means 80 is designed to be adapted to and retain bag attachment means 56 as loops which support bulk bag 50 when inverted. An adaptation to mount 84, provides a means to attach perimeter retainer means 80 to a machine designed to invert a container 300 or 700. Angled section 86 provides a resting point for bulk bag attachment means 56, upon which, bulk bag attachment means 56 will support bulk bag 50 when inverted. Perimeter retainer means 80, in a preferred embodiment, can be constructed of tube or channel material 82 extending downward past the adaptation to mount 84.

Since alternative bag attachment means, illustrated as loops 56 on bulk bag 50, can be supplied in various forms as discussed above, accordingly, perimeter retainer means 80 can be of varying design to be adapted to such alternative bag attachment means without departing from the present invention.

As illustrated in exploded view FIG. 13, bulk bag attachment means 56 shown as loops are hooked underneath perimeter retainer means 80 while means to support a bulk bag body upright 90 can be inserted into and through a hollow opening 88 perimeter retainer means 80. Means to support a bulk bag body upright 90 can be further inserted past bulk bag attachment means illustrated as loops 56 and through or into side support means 60 illustrated as side sleeve until reaching closed end 62. Side sleeve 60 or hollow opening 88 perimeter retainer means 80 may be constructed with sufficient degree of fit to hold means to support a bulk bag body upright 90 in place, or means (not shown) can be provided to connect and hold means to support a bulk bag body upright 90 in place, for example, to perimeter retainer means 80 or a member 310 of machine designed to invert a container 300 or 700. When inverted, bag attachment means 56 are retained by angled section 86 on adaptation to mount 84 of perimeter retainer means 80. Means to support a bulk bag body upright 90, when engaged with side support means 60, keep bulk bag attachment means 56 in place during inverting. As product is discharged from inverted bulk bag 50, the perimeter of said bulk bag 50 will be retained and bulk bag body 64 will remain upright.

Means to support a bulk bag body upright 90 keep bulk bag body 64 from sagging thereby contributing to complete product discharge from bulk bag 50. An alternative embodiment utilizes means to support a bulk bag body upright 90 that are shorter than the side seam dimension of bulk bag body 64 in conjunction with a bulk bag 50 supplied with side support means 60 that are correspondingly shorter. The length of both items, means to support a bulk bag body upright 90 and side support means 60, can be dependent on the volume of the cone section 70. When inverted, product stored in bulk bag 50 will fill the volume of cone section 70 thereby creating empty space in bulk bag body 64. In applications where vertical height is limited, it is possible to fold down the fabric of bulk bag body 64 where a void is created to reduce the overall height of inverted bulk bag 50.

In accordance with a further aspect of the invention, as illustrated in FIG. 14, perimeter retainer means 100 is provided to retain an inverted bulk bag 50 supplied with horizontal sleeve attachments 72. Horizontal sleeve attachment 72 can be sewn into the top horizontal corner between bulk bag body 64 and cone section 70 with spout 54 and inlet/outlet 52 facing upward. Perimeter retainer means 100, as illustrated, is shown as a cylindrical or channel type member in a horizontal orientation for mounting to a machine for inverting a container 300 or 700. Sleeve support member(s)1 10, can slide through hollow section 102 of perimeter retainer means 100, slide further through horizontal sleeve 72 and through a hollow section 102 of a second perimeter retainer means 100. Horizontal sleeve 72 and/or perimeter retainer means 100 may be constructed with sufficient degree of fit to hold sleeve support member 110 in place or a means (not shown) can be provided to connect and hold sleeve support member 110 in place. A receptacle 104 can be provided to receive means to support a bulk bag body upright 90. Receptacle 104 can be adapted directly to perimeter retainer means 100 or can mount directly upon machine designed to invert a container 300 or 700. Means to support a bulk bag body upright 90 can be inserted through receptacle 104.

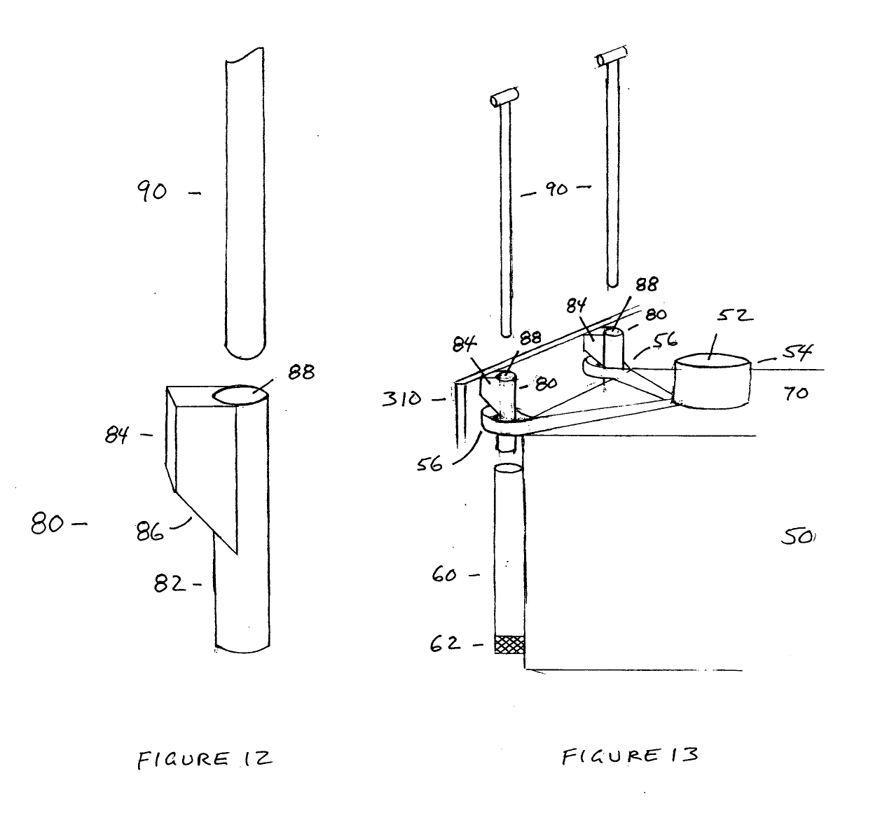

FIG. 15 shows an example of how means to support a bulk bag body upright 90 can be inserted into and through a hollow opening 106 in tube or channel 104. Means to support a bulk bag body upright 90 can be further inserted through or into or attach to side support means 60 illustrated as side sleeve 60 until reaching closed end 62. Side sleeve 60 or hollow opening 106 in tube or channel 104 may be constructed with sufficient degree of fit to hold means to support a bulk bag body upright 90 in place, or a means (not shown) can be provided to connect and hold means to support a bulk bag body upright 90 in place, for example, to alternative receptacle 104 or perimeter retainer means 100 or a member 310 of machine designed to invert a container 300 or 700. Alternative bag side support means 60 illustrated as side sleeves 60 along bulk bag sides 64 can include but are not limited to: loops, pockets, sleeves, strings, tabs, tabs with eyelets, tabs with Velcro, straps, rings, rigid adaptations, hooks or clamps and can be designed to accept an inserting member 90 and can also be designed to attach to alternative means to support a bulk body upright 90 supplied with a connecting adaptation. Accordingly, means to support a bulk bag body upright 90 can be of varying design to adapt to such alternative bag side support means 60 without departing from the present invention.

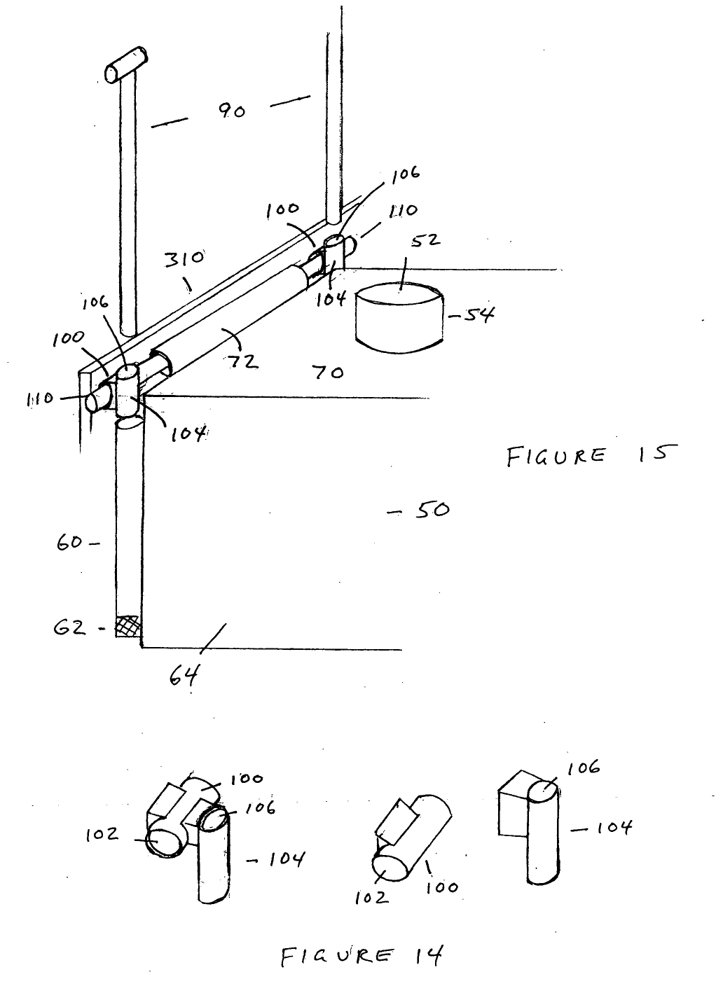

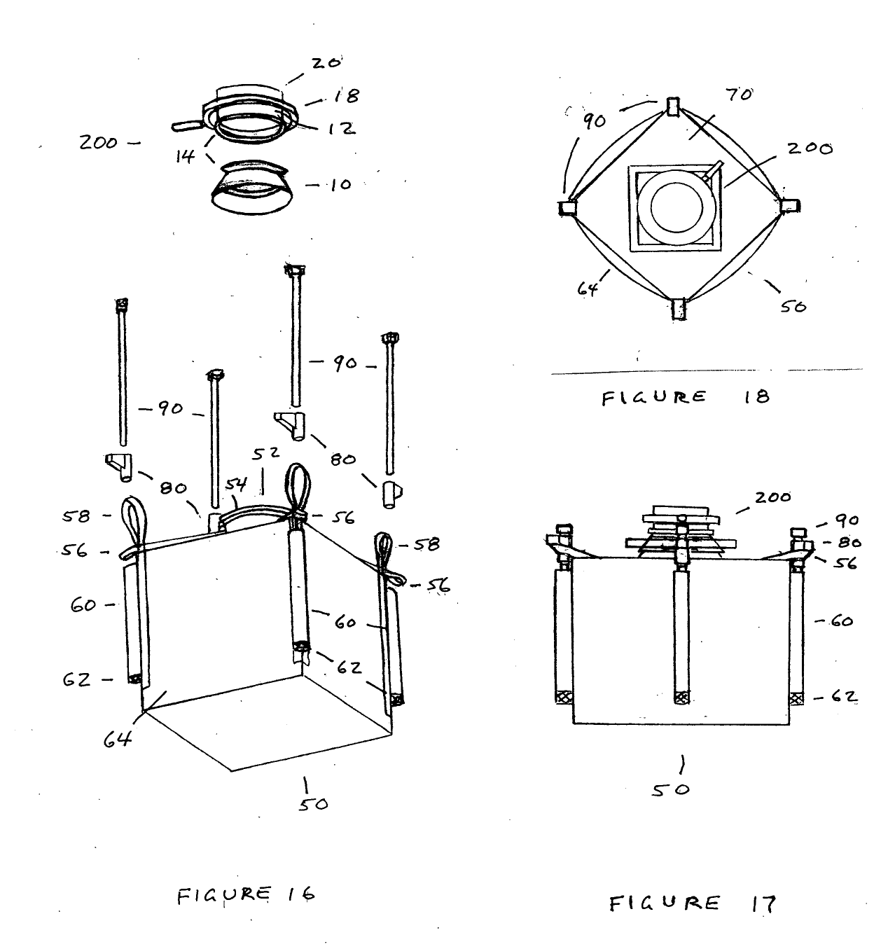

The relationship of the perimeter retainer means 80 to the adapter assembly 200 will be better understood following a description of the following figures. FIG. 16 provides an exploded view of the preferred embodiments of the present invention in relation to their adaptation to a bulk bag 50. With bulk bag 50 disposed in an upright position, spout 54 with annulus 52 are facing upward. Lifting and filling loops 58 are shown but are not absolutely necessary for either purpose. It is possible to utilize bag attachment means 56 for lifting and filling. Alternatively, lifting and filling loops 58 can be utilized in the bag attachment means 56 function. However, in the illustrated embodiment, bag attachment means 56 are illustrated as loops stitched to the cone section 70 of bulk bag 50 and are provided with diameter and length to support inverted bulk bag 50 perimeter to fit perimeter retainer means 80.

In exploded view FIG. 16, following the preferred procedure, bulk bag 50 is disposed in an upright position within machine designed to invert a container 300 or 700 (not shown). Bulk bag attachment means 56 are secured to perimeter retainer means 800 followed by inserting means to support a bulk bag body upright 90 into perimeter retainer means 80 and further inserting means to support a bulk bag body upright 90 into bag side support means 60 until contacting closed ends 62. While bag sides 64 remain upright when filled with product, the inverted bulk bag 50 when discharging product will be able to maintain upright sides 64 as it empties, thus, residual product in the bulk bag will not be trapped in folds of fabric. Perimeter retainer means 80 are shown independently and not mounted to machine designed to invert a container 300 or 700 for clarity.

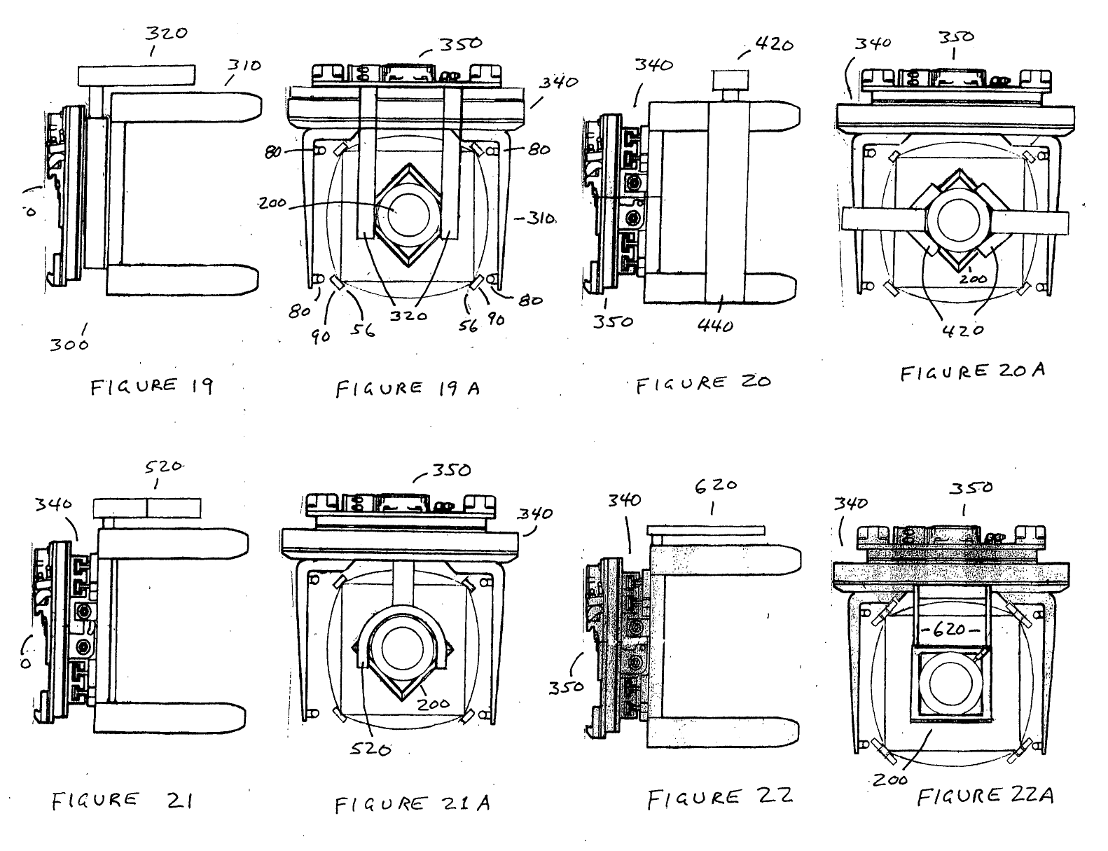

Adapter assembly 200 is constructed upon bulk bag 50 while in an upright position. Adapter section 10 is rested upon bulk bag cone 70, which lies flat, and over inlet/outlet 52. Spout 54 is pulled up through adapter section 10 and folded down over flange 14 of adapter section 10. Extension adapter 12 is lowered either manually or may be attached to the stabilizer arm illustrated as 320, 420, 520 and 620 in FIGS. 19 through 22A that is part of machine designed to invert a container 300 or 700. Alternatively, adapter section 10 may be mounted to the stabilizer arm 320, 420, 520, or 620 and may also be equipped, for example, with moveable support bracket components 40, 42 and 44 interconnecting the adapter section 10 with the extension adapter section 12. Adapter extension section 12 may also be fitted with a flow control valve or metering device 18 and may also have an extension stub 20 to facilitate docking to a process inlet or conveyance equipment. When extension adapter 12 flange 14 is lowered upon adapter section 10 flange 14, a clamp as illustrated as 18 or 22 locks extension adapter section 12 against adapter section 10 with spout 54 pressed between as a gasket. Spout 54 can be untied either before clamping or after clamping adapter assembly 200 components.

FIG. 17 offers an elevational view of the assembled components of adapter assembly 200, perimeter retainer means 80, means to support a bulk bag body upright 90 and bulk bag 50. FIG. 18 shows a plan view of the same assembled components. Perimeter retainer means 80 are shown independently and not mounted to machine designed to invert a container 300 or 700 for clarity.

FIGS. 19 through 22A show machine for inverting a container 300. FIG. 19 is illustrated with a three sided frame 310 with horizontal inverter 350. Stabilizer arm 320 is illustrated in a contracted position.

FIGS. 19A through 22A show machine designed to invert a container 300 with clamp device 340 and horizontal inverter 350. Clamp device 340 may be controlled by any powered means such as hydraulic or pneumatic cylinder, screw jack or other mechanical means and can be utilized to squeeze the bulk bag. The present invention is concerned with manipulating the contents of bulk bag 50. Bulk bags 50 are filled through the top, shipped upright and sometimes stacked two or three high during storage. The contents often become packed making product discharge difficult or impossible without assistance. FIGS. 19A through 22A and FIGS. 23 through 26 are illustrated showing clamp mechanism 340 that can serve the purpose of squeezing bulk bag 50 prior to lifting and inverting and also during discharging of contents. An alternative use for clamp 340 is to use clamp 340 to squeeze and support bulk bag 50 when the machine for inverting a container 300 and 700 is supplied without a base. By squeezing certain products in a bulk bag 50, bulk bag 50 will remain stable and can be lifted off of a pallet, thereby leaving the pallet on the floor. Bulk bag 50 can be inverted and positioned for discharge.

FIG. 19A shows a plan view of stabilizer arm 320 comprised of two stabilizer arms mounted on a powered extension and contracting apparatus 360. Bulk bag 50 is shown placed within the frame 310 of the machine for inverting containers 300. A horizontal rotator 350 inverts the machine frame 310 and the bulk bag 50. Bag attachment means 56 are not connected to perimeter retainer means 80 for clarity.

FIG. 20 shows an elevational view of side mounted powered extension and contracting apparatus 440 with custom shaped brackets 420 to hold adapter assembly 200 from the sides. FIG. 20A provides a plan view of custom bracket 420 holding adapter assembly 200. Bag attachment means 56 are not connected to perimeter retainer means 80 for clarity.

FIG. 21 shows an elevational view of a machine for inverting a container 300 with a U shaped custom bracket 520. FIG. 21A shows a plan view of U shaped custom bracket 520 holding adapter assembly 200. Bag attachment means 56 are not connected to perimeter retainer means 80 for clarity.

FIG. 22 shows an elevational view of a machine designed to invert a container 300 with stabilizer arm 620 with prong or tine like extensions. FIG. 22A provides a plan view of stabilizer 620 which inserts into the open ends 34 of framework 30 so that adapter assembly 200 can be mounted on stabilizer 620 and can be adjusted to center adapter assembly 200 over the center of bulk bag 50. Another alternative could be to have a custom shaped bracket similar to 520 with slots (not shown) so that the bracket 520 can be adjusted on the prongs or tines 620 to locate properly onto adapter assembly 200 and its framework 30.

After review of the features described in FIGS. 19 through 22A, one skilled in the art will appreciate that the means of stabilizing adapter assembly 200 and/or bulk bag 50 may be done in various ways without departing from my invention and that the invention is not necessarily so limited.

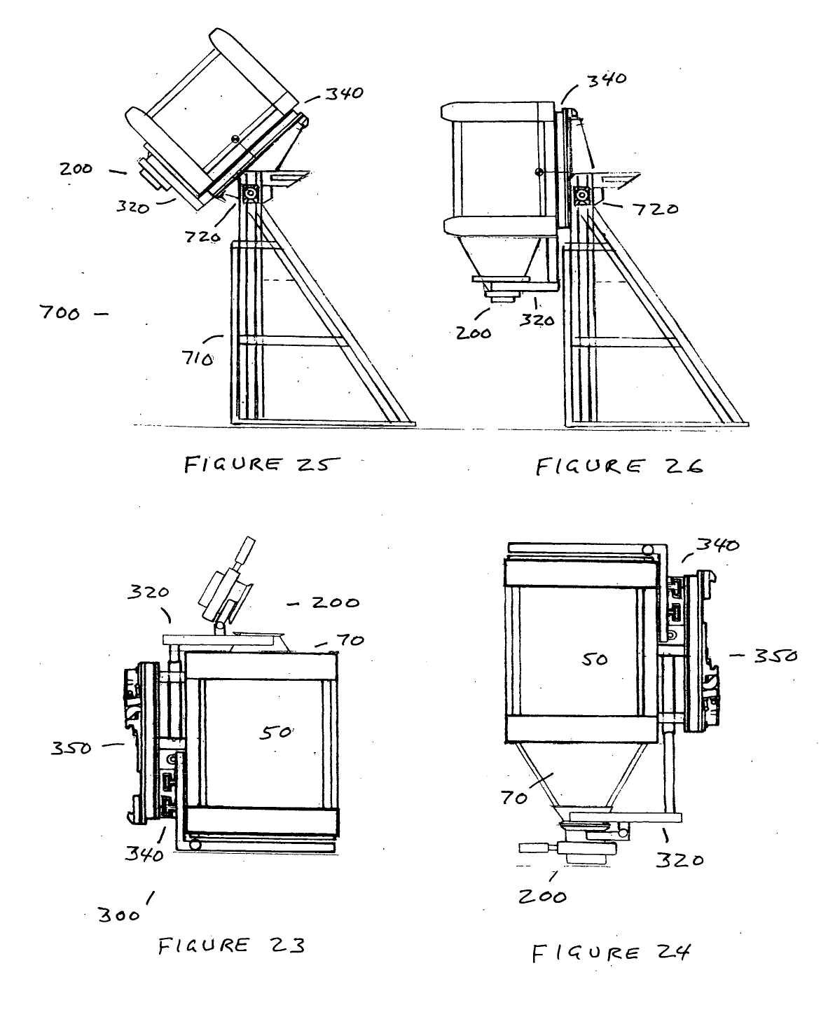

A machine designed to invert a container 300 as shown in FIGS. 23 and 24 can be mounted on a stand or a lift and can also be mounted on a forklift. The stand or lift can be stationary or mobile and may also be capable of pivoting.

Thus, in the present embodiment, the assembled components can be viewed in FIG. 23 with bulk bag 50 placed within machine designed to invert a container 300. Machine designed to invert a container 300 is shown comprised of a horizontal rotator 350 that typically mounts to a stand, a lift or a forklift (not shown). A lift (not shown) may have pivoting capability to allow the inverted bulk bag 50 to be positioned over a process inlet or conveyance equipment. Stabilizer arm 320 is shown in a contracted position while the bulk bag 50 spout 54 is prepared with adapter assembly 200. As illustrated, adapter assembly 200 is shown with a base bracket 46 connected to adapter section 10 supporting a connecting member 44 to a hinge 42 that allows a top section bracket 40 connected to extension adapter section 12 to pivot up and down.

If a lift is provided, machine designed to invert a bulk bag 300 is lifted to an appropriate height and horizontal rotator 350 inverts bulk bag 50. When inversion is completed, stabilizer arm 320 extends until adapter assembly 200 and cone section 70 is fully extended. FIG. 24 provides an elevational view of stabilizer arm 320 extended with adapter assembly 200 attached to spout 54. At this point, if the lift is provided with pivoting function, bulk bag 50 can be moved over a process inlet or conveyance equipment inlet. Using the lift, bulk bag 50 can be lowered to dock with a process inlet or conveyance equipment. Another approach could be to lift and invert bulk bag 50, pivot over a process inlet or conveyance equipment inlet, then extend adapter assembly 200 to dock with a process inlet or conveyance equipment inlet. Finally, flow valve or metering device 18 can be opened allowing product to flow through bulk bag 50 opening 52.

In the illustrated embodiment shown in FIGS. 25 and 26, the present invention employs a typical container dumper 700 to achieve inverted position. A container dumper 700 is normally used to invert a rigid container such as a box, drum or bin. Often times, a cone constructed of steel, aluminum, alloy or plastic (not shown) with a matching perimeter to that of the container is lowered onto the container, or in some cases, the base of the container is raised thus lifting the container perimeter to engage the perimeter of the cone. Whether a cone is used or not, the container is inverted over a pivot point 720 and then discharged. If a valve or flow control device 18 is mounted on the cone, it can be used to regulate the flow of product from the container. In instances when height needs to be achieve in order to discharge the container contents, the container is first raised to an appropriate height with a mechanism that may be similar to a fork lift mast raising mechanism 710. When the desired height is achieved, the container is inverted over a pivot point 720 and then discharged. Similarly, as illustrated in FIGS. 25 and 26, stabilizer arm 320 is in a contracted position with bulk bag 50 spout 54 prepared with adapter assembly 200. In the particular device illustrated, bulk bag 50, secured in machine designed to invert a container 700, is lifted on lift 710 and inverted over pivot point 720. When inversion is completed, stabilizer arm 320 extends until adapter assembly 200 and cone section 70 is fully extended. Finally, flow valve or metering device 18 can be opened allowing product to flow through bulk bag 50 opening 52. Perimeter retainer means 80 could be mounted to a member of machine designed to invert a container 700 in a similar manner as that shown in FIGS. 19A, 20A, 21A and 22A. Perimeter retainer means 100 could be mounted in a similar manner as that shown in FIG. 15.

It is contemplated that in some cases, adapter assembly 200 may not be utilized. It could be desirable to invert bulk bag 50 and retain the perimeter using perimeter retainer means 80 and simply untie bulk bag 50 spout 54 to discharge bulk bag 50. Relying solely on perimeter retainer means 80 to hold bulk bag 50 in place without employing stabilizer arm 320 is possible. However, stabilizer arm 320 can be employed to contract against bulk bag 50 top cone section 70 of bulk bag 50 prior to and during inverting. Stabilizer arm 320 can be extended allowing bulk bag 50 top cone section 70 to extend. Spout 54 can then be untied for discharging the contents of bulk bag 50.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for the discharge of bulk bags comprising:
an adapter section including an outwardly extending flange adapted for being engaged by a connecting means;
an extension adapter section with matching outwardly extending flange adapted for being engaged by a connecting means; and
a connecting means to secure said adapter section and said extension adapter section together.

2. An apparatus for the discharge of bulk bags as claimed in claim 1 wherein:
said adapter assembly is comprised in a form that is cylindrical, conical, square or any desired geometric design

3. An apparatus for the discharge of bulk bags as claimed in claim 1 wherein:
said connecting means is a surrounding clamp

4. An apparatus for the discharge of bulk bags as claimed in claim 1 wherein:
said connecting means is comprised of multi part clamping means

5. An apparatus for the discharge of bulk bags as claimed in claim 4 wherein:
said connecting means is comprised of a multi part clamping means mounted upon said adapter assembly

6. An apparatus for the discharge of bulk bags as claimed in claim 1 further comprising
a moveable means with support brackets moveably interconnecting said adapter assembly sections allowing the top portion, said extension adapter section, to be unclamped, opened, closed and clamped while remaining connected to the bottom portion, said adapter section

7. An apparatus for the discharge of bulk bags as claimed in claim 6 wherein:
said moveable means is comprised of pivoting components to separate components side to side

8. An apparatus for the discharge of bulk bags as claimed in claim 6 wherein:
said moveable means is comprised of hinge components to separate components in a vertical arc

9. An apparatus for the discharge of bulk bags as claimed in claim 6 wherein:
said moveable means is comprised of vertical components to separate components vertically

10. An apparatus for the discharge of bulk bags as claimed in claim 1 further comprising
a valve or flow control device adapted to be connected to said adapter extension section

11. An apparatus for the discharge of bulk bags as claimed in claim 10 wherein:
said valve or flow control device adapted to be connected to said adapter extension section is comprised of any of the family of said valve or flow control devices including those presently available or of said valve or flow control devices developed in the future

12. An apparatus for the discharge of bulk bags as claimed in claim 10 wherein:
said a valve or flow control device is adapted with a matching outwardly extending flange adapted for being engaged by a connecting means, to mount directly on said adapter section including an outwardly extending flange adapted for being engaged by a connecting means

13. An apparatus for the discharge of bulk bags as claimed in claim 1 wherein:
said adapter assembly is adapted to be engaged by components of a machine for inverting a container

14. An apparatus for the discharge of bulk bags as claimed in claim 13 further comprising:
at least one member mounted on said adapter assembly, to receive at least one stabilizing member of said machine for inverting a container

15. An apparatus for the discharge of bulk bags as claimed in claim 13 further comprising:
at least one member mounted on said adapter assembly constructed of tubular or channel material, to receive at least one inserting member of said stabilizing member of said machine for inverting a container

16. An apparatus for the discharge of bulk bags as claimed in claim 13 wherein:
said adapter assembly, adapted to be engaged by components of a machine for inverting a container, is mounted directly upon at least one said stabilizing member of said machine for inverting a container

17. An apparatus for the discharge of bulk bags as claimed in claim 1 further comprising:
framework encompassing said adapter assembly

18. An apparatus for the discharge of bulk bags as claimed in claim 17 wherein:
said framework encompassing said adapter assembly comprises at least one member constructed of tube or channel material, open at the ends, to receive at least one stabilizing member of said machine for inverting a container

19. An apparatus for the discharge of bulk bags comprising:
perimeter retainer means, to hold a bulk bag in position while inverted for discharging its contents

20. An apparatus for the discharge of bulk bags as claimed in claim 19 wherein:
said perimeter retainer means is adapted to be mounted upon a machine for inverting a container

21. An apparatus for the discharge of bulk bags as claimed in claim 20 further comprising:
means to retain a bulk bag supplied with bag attachment means, for example but not limited to loops, sleeves, strings, tabs, tabs with eyelets, straps, rings, rigid adaptations, hooks, clamps, positioned about the top perimeter of a pre-inverted said bulk bag hence is positioned about the bottom perimeter of a post-inverted said bulk bag

22. An apparatus for the discharge of bulk bags as claimed in claim 19 further comprising:
means to support said bulk bag body upright

23. An apparatus for the discharge of bulk bags as claimed in claim 19 said perimeter retainer means further comprising:
tubular or channel member with a spacer member that affixes said tubular or channel member, adapted to retain said inverted bulk bag, to a member that comprises said machine for inverting a container,

24. An apparatus for the discharge of bulk bags as claimed in claim 22 and 23 further comprising the step(s) of:
a) inserting said means to support said bulk bag body upright through said tubular or channel perimeter retainer means;
b) further inserting said means to support said bulk bag body upright through, or attaching to, said bulk bag attachment means
c) further inserting said means to support said bulk bag body upright into a side support means or attaching to said side support means supplied upon said bulk bag

25. An apparatus for the discharge of bulk bags as claimed in claim 19 further comprising:
means to retain inverted said bulk bag with horizontal sleeve attachment means

26. An apparatus for the discharge of bulk bags as claimed in claim 25 further comprising:
tubular or channel receptacles, adapted to mount horizontally upon a machine for inverting a container

27. An apparatus for the discharge of bulk bags as claimed in claim 26 further comprising:
sleeve support member(s) insertable through said means to retain said bulk

28. An apparatus for the discharge of bulk bags as claimed in claim 25 further comprising the step(s) of
a) inserting said sleeve support member(s) through a first said tubular or channel receptacle bag retainer means
b) further inserting said sleeve support member(s) through said horizontal bag sleeve
c) further inserting said sleeve support member(s) through a second said tubular or channel receptacle bag retainer means

29. An apparatus for the discharge of bulk bags as claimed in claim 25 further comprising:
receptacles for attaching said sleeve support member(s) by means other than inserting said sleeve support member(s) through said receptacles

30. An apparatus for the discharge of bulk bags comprising the step(s) of:
a) disposing said bulk bag with said spout facing upward within a machine for inverting a container;
b) connecting said bag attachment means to said perimeter retainer means as required;
c) connecting said means to support said bulk bag body upright (if supplied);
d) positioning said adapter assembly over said spout of said bulk bag either manually or by lowering said stabilizing member of said machine for inverting a container;
e) separating said adapter section and said extension adapter section;
f) pulling said bulk bag spout up and through adapter section orifice and folding said spout down over said flange of said adapter section;
g) placing said extension adapter section matching flange over said folded spout and over said adapter assembly flange;
h) engaging said extension section flange firmly over said adapter section flange utilizing said connection means;
i) raising (if supplied with a lift) and inverting said bulk bag;
j) positioning said bulk bag over desired apparatus;
k) extending said stabilizing member of said machine for inverting a container, thereby extending said spout of said bulk bag from said body of said bulk bag
l) activating said flow control device to controllably allow said material to flow; and
m) activating said flow control device to controllably stop said material flow
